(19) United States
(12) Patent Application Publication
(10) Pub. No.: US 2020/0050704 A1
(43) Pub. Date: Feb. 13, 2020

(54) Job searching system and method with an improved job application

(71) Applicant: Jamarius Gladney, Clinton, MS (US)

(72) Inventor: Jamarius Gladney, Clinton, MS (US)

(21) Appl. No.: 16/100,023

(22) Filed: Aug. 9, 2018

(51) Int. Cl. G06F 17/30; G06Q 10/06; G06F 17/24

(52) U.S. Cl. CPC G06F 17/30867; G06F 17/30696; G06F 17/243; G06Q 10/063112; G06F 17/30675

(57) ABSTRACT

A job searching system and method is disclosed that gathers applicants to fill out a single job application per job sector in a sector format. This information can then be passed directly to employers in a way that will allow you to bypass filling out each employer's job application individually which will be accepted by multiple employers under that sector from one or more applicant. This system also allows prospective employers and/or recruiters to fill out their own ideal job application to compare with the applicant's application. In response to the employer's query, the applicants are then sorted from best to worst based on common parameters between the employer's ideal application and the applicant's application. This provides the best matching job applicant for the position. In addition, the applicant will also be informed on the color rating of their application after applying.

### TECHNICAL FIELD

This invention relates to job searching systems and methods and more particularly, to an improved job application method that allows the applicant to bypass filling out each employer's job application individually by filling out one job application per job sector.

### BACKGROUND

Note: For simplicity of repetition of words, the words: he, him, his, their, them, and they are used throughout this description not being gender specific but rather being a means of describing job seeker/applicants, employer/recruiters, job applications, and drawings. In other words, he, him, his, their, them, and they are another word for job seeker/applicants, employer/recruiters, job applications, and drawings and not boy or girl.

The job searching system and method art is relatively young. As such, many inventors are experimenting with various methods of achieving optimized results associated with the industry in general.

Job searching systems and methods are generally comprised of companies that are hiring for a specific job and applicants who are seeking a specific job. In most prior art, companies advertise their jobs through a job searching website in which the applicants then apply for these jobs by filling out a company's application.

U.S. Pat. No. 9,959,525 reveals a job searching and matching system that gathers job seeker's information in the form of job seeker parameters and gathers job information in the form of job parameters from prospective employers. In addition, the system preferably can obtain further job openings to have as broad a base of opportunities to present to a job seeker as possible. The system then correlates the available jobs, tracks all job seeker inquiries, and looks for commonalities and correlations between job parameters, interests of job seekers, features of job seeker resumes, past action of the job seeker, and job description to narrow in on a more accurate set of suggested jobs being presented to the job seeker. Further, the system and method can be used by the employer/recruiter to similarly match prospective job seekers to an employer/recruiter's job.

Existing job searching systems and methods consist of generally similar job searching methods. Typical job searching systems and methods consist of a job seeker who searches, reviews, and/or analyzes various jobs of their choice through a search engine. Another way of doing this is by having a software matching program that matches a job seeker with an ideal job based off their commonalities and correlations between each other. The job seeker then fills out an application for each job he is interested in. Further, the employer receiving the applications will have to sort out the good applicants from the bad applicants which can take days, weeks, or even months considering the hundreds of applications being submitted each week.

However, available search engines still often require job seekers to fill out a so-called new job application for every job he applies for and employers to manually sort out every job application they receive from job applicants. It would be desirable then to provide a super application for each job sector for job seekers to fill out once and save to file and an ideal job application for employers to fill out once and save to file. This will save applicants time by not filling out individual job applications for each company he wishes to apply for which could take hours and save employers time by using their ideal application as a sorting method to compare with the applicants' application to sort them from best to worst depending on what the employer is looking for. This will allow job seekers more time to apply to more jobs which means more opportunities, and the employers will be able to find applicants that are the cream of the crop without having to sort through the hundreds of applications just to find one or none.

### BRIEF DESCRIPTION OF THE DRAWINGS

Note: For simplicity of illustrations sent, inbox, draft, new folder, and trash of common job searching industry sections are not fully described as they are known to those with skill in the art. When they are shown, it is purely for illustrate purposes and not intended to capture all embodiments of the invention disclosed. Various embodiments are disclosed in the following detailed description. The disclosure will be better understood when consideration is given to the following detailed description taken in conjunction with the accompanying drawing figures wherein:

FIG. 1 shows an overall flow diagram view of an illustrative embodiment of a job seeker job searching and applying system incorporating features of the present disclosure.

FIG. 2 is an exemplary web page screen that is presented to the job seeker as a main/home page in an illustrative embodiment incorporating features of the present discloser.

FIG. 3 is an exemplary web page screen for a job seeker upon selecting the “Search” bar in FIG. 2

FIG. 4 is an exemplary web page screen that is presented to a job seeker once the results of the job he has searched for in FIG. 3 is available in an illustrative embodiment incorporating features of the present disclosure.

FIG. 5 shows an overall flow diagram view of an illustrative embodiment of an employer/recruiter's receiving and reviewing application system incorporating features of the present discloser.

FIG. 6 is a process system in which the employer/recruiter's application is compared to the applicant's application in accordance with an embodiment of the present discloser.

FIG. 7 is an exemplary web page screen that is presented to the employer/recruiter as a main/home page in an illustrative embodiment incorporating features of the present discloser.

FIG. 8 is an exemplary web page screen presented to the employer/recruiter upon selecting a received applicant's application to view.

FIG. 9 is an exemplary side menu bar presented to any user, either a job seeker or an employer/recruiter incorporating features of the present discloser.

FIG. 10 is a simplified process flow diagram of “sent messages” for any user, either a job seeker or an employer/recruiter in accordance with an embodiment of the present discloser.

FIG. 11 is an exemplary web page screen of FIG. 10 presented to either a job seeker or an employer/recruiter incorporating features of the present discloser.

FIG. 12 is an exemplary web page screen of a sent message clicked for viewing in FIG. 11

FIG. 13 is a simplified process flow diagram of “inbox messages” for any user, either a job seeker or an employer/recruiter in accordance with an embodiment of the present discloser.

FIG. 14 is an exemplary web page screen of FIG. 13 presented to either a job seeker or an employer/recruiter incorporating features of the present discloser.

FIG. 15 is an exemplary web page screen of an inbox message clicked for viewing in FIG. 14

FIG. 16 is a process flow diagram of “drafts” for an employer/recruiter in accordance with an embodiment of the present discloser.

FIG. 17 is a process flow diagram of “drafts” for a job seeker in accordance with an embodiment of the present discloser.

FIG. 18 is an exemplary web page screen of a draft clicked for viewing in FIG. 16 and/or FIG. 17.

FIG. 19 is a simplified process flow diagram of “create/upload resume’ presented to a job seeker in accordance with an embodiment of the present discloser.

FIG. 20 is an exemplary web page screen of an entry-level resume or a professional-resume clicked for viewing in FIG. 19.

FIG. 21 is a simplified process flow diagram of “sector's application(s)” for any user, either a job seeker or an employer/recruiter in accordance with an embodiment of the present discloser.

FIG. 22 is an exemplary web page screen of FIG. 21 for job seekers.

FIG. 23 is an exemplary web page screen of FIG. 21 for employer/recruiters.

FIG. 24 is an exemplary web page screen of an application clicked for filling or updating in FIG. 22 and FIG. 23.

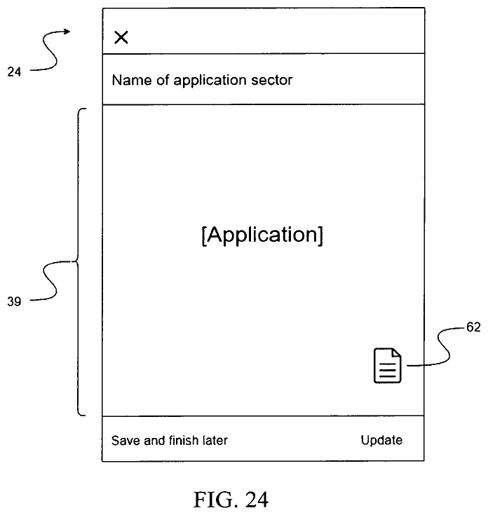

FIG. 25 is a simplified process flow diagram of “new folder” for any user, either a job seeker or an employer/recruiter in accordance with an embodiment of the present discloser.

FIG. 26 is an exemplary web page screen of FIG. 25 presented to either a job seeker or an employer/recruiter.

FIG. 27 is a simplified process flow diagram of “trash” for any user, either a job seeker or an employer/recruiter in accordance with an embodiment of the present discloser.

### DETAILED DESCRIPTION

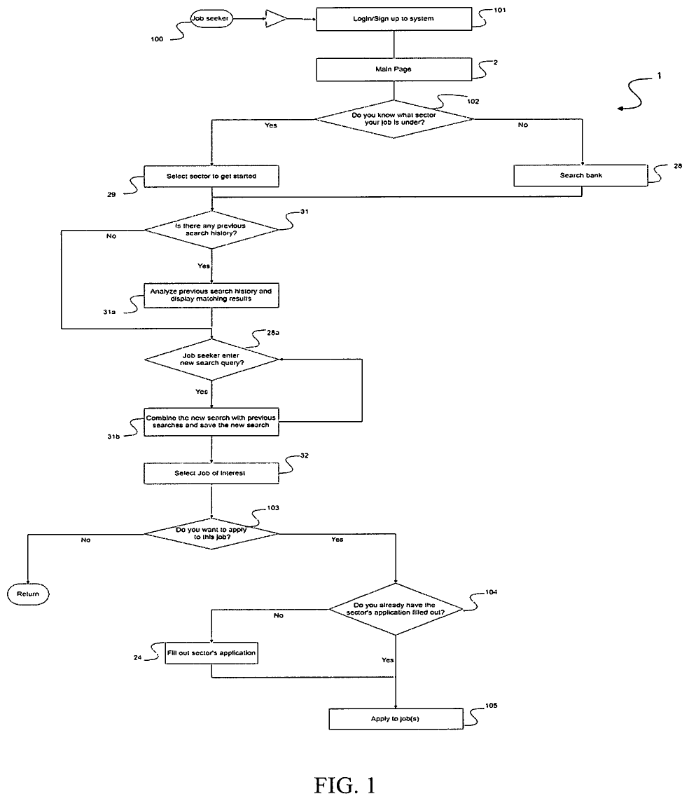

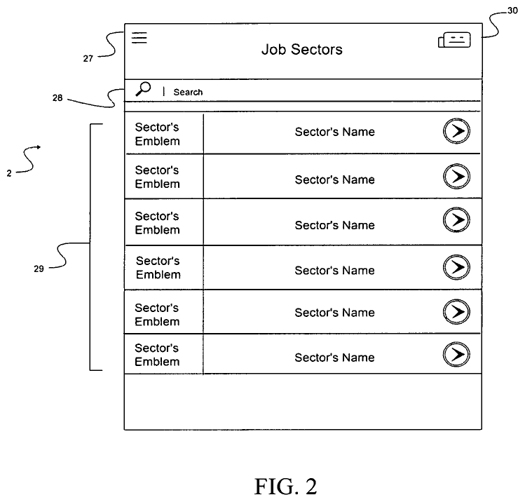

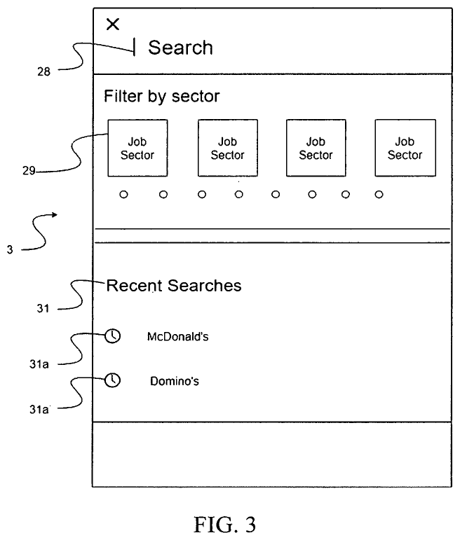

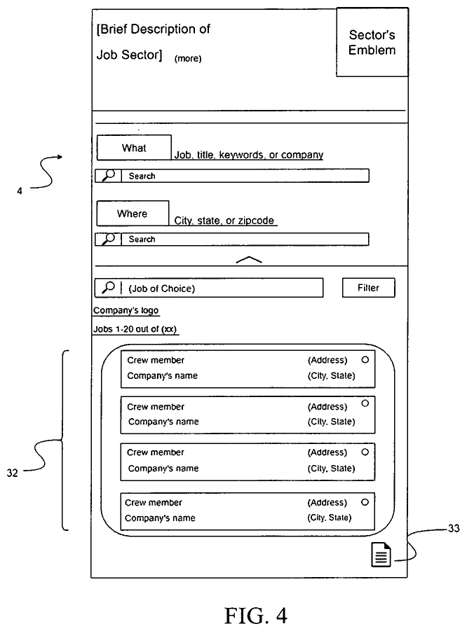

The various embodiment and variations thereof illustrated in the accompanying Figures and/or described herein are merely exemplary and are not meant to limit the scope of the invention. It is to be appreciated that numerous variation of the invention has been contemplated as would be obvious to one of ordinary skill in the art with the benefit of this disclosure. Rather, the scope and breadth afforded this document should only be limited by the claims provided herein while applying either the plain meaning to each of the terms and phrases in the claims or the meaning clearly and unambiguously provided in this specification. Throughout this specification and in the drawing, like numerals will be utilized to identify like modules, operations, and elements in the accompanying drawing figures. A flow diagram of one exemplary embodiment of the job search architecture software system 1 is shown in FIG. 1 regarding job seekers. FIG. 1 shows a sequence of operations 1 when a job seeker 100 accesses the job search system. Here the job seeker 100 either signs up or login 101 into the system and is routed to the main page 2. The main page 2 of an exemplary job seeker web page is shown in FIG. 2. In FIG. 2, the job seeker 100 is presented with a menu icon 27 to be able to navigate through different parts of the website, a main page icon 30 which will direct the job seeker back to their main page, and a search bar 28 for searching jobs they do not know the sector of 102. If the job seeker then clicks on the search bar 28, the screen 3 shown in FIG. 3 is presented. Here the job seeker can filter a job by its sector 29 and search it. Below this is a recent search query 31 that is presented to a job seeker of all the jobs that he has recently searched 31a. If the job seeker enters a new search query 28a, then it is combined with the previous searches 31b if existing to find new jobs of this type to display. When a job seeker searches for a job, then screen 4 shown in FIG. 4 is presented. Here the job seeker is presented with all the jobs 32 that he searched for in hopes of finding one to apply for. If the job seeker decides to apply for a job 103 he will have to complete the sector's application 24 if not already completed 104. At the bottom of screen 4 is a sector's application icon 33 for the job seeker to fill out. This allows the job seeker to apply 105 for any job under this job sector.

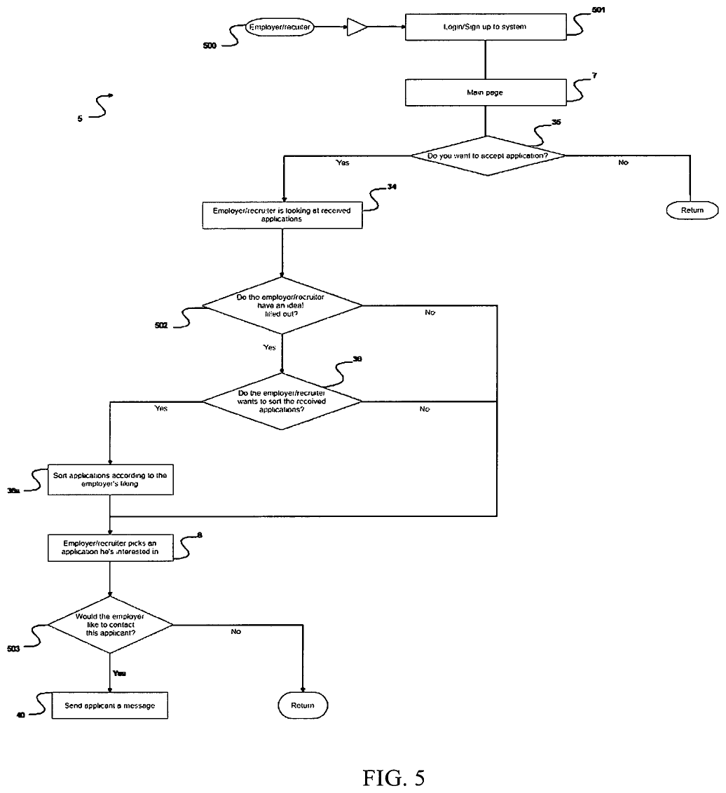

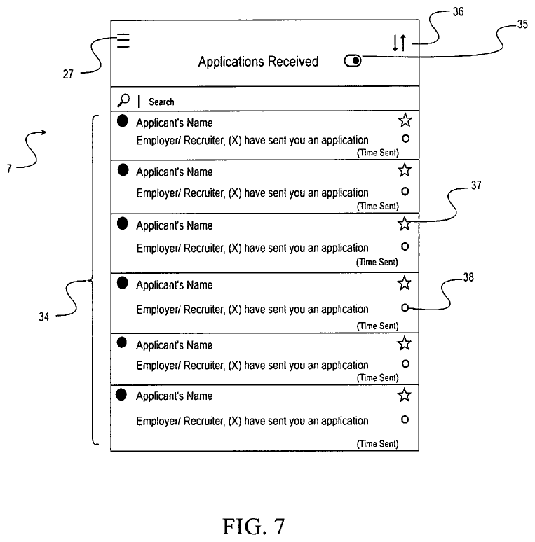

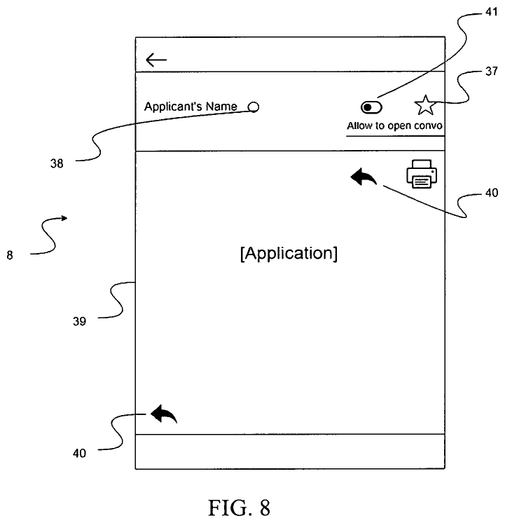

Regarding employers/recruiters, a flow diagram of one exemplary embodiment of the job search architecture software system 5 is shown in FIG. 5. FIG. 5 shows a sequence of operations 5 when an employer/recruiter 500 accesses the job search system. Here the employer 500 either signs up or login 501 into the system and is routed to the main page 7. The main page 7 of an exemplary employer/recruiter web page is shown in FIG. 7. In FIG. 7, the employer/recruiter is presented with a menu icon 27 that is slightly different from the job seeker's icon in that it has no resume section and only has one job sector 29 in its “sector's application” 51. This allows the employer to fill out his own sector's application 24 to represent as an ideal application to be compared with the job seekers applications and as a result rate the job seekers application by color of importance 38. Further, FIG. 7 also presents a turn on and off button 35 that allows the employer/recruiter to accept or stop accepting applications, and a sorting icon 36 that sorts received applications 34 to the employer's liking 36a. Color sorting is only possible if the employer has an ideal application filled out 502. Once the employer reviews a job seeker's application FIG. 8 8 and wants to contact him 503, he will have to open a conversation 41 and send the job seeker a message 40. The job seeker will be informed when a conversation is opened by an orange star 37 appearing beside the message. If the star is not orange, then the conversation is no longer open.

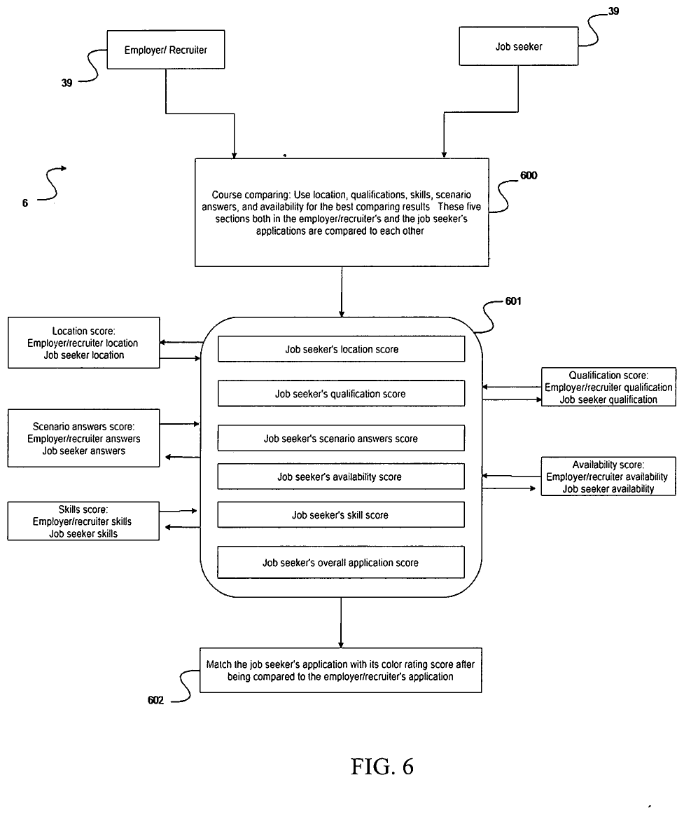

FIG. 6 is an embodiment of the matching algorithm 6 used in the sorting module 36 for comparing the employer/recruiter's application to the applicant's application. In this exemplary embodiment, the matching algorithm 6 involves a twostep approach. First, one or more of the location, qualification, skill, scenario answer, and availability from the job seeker's application 39 and one or more location, qualification, skill, scenario answer, and availability from the employers/recruiter's application 39 are retrieved from the database and are compared in a course matching operation 600. The operation 600 then scores 601 and sorts the applicant's application by a specific color 602 of one that is considered close to the identity of the employer's application, one that is considered not so close to the identity of the employer's application, and one that is considered far from close to the identity of the employer's application. This is expressed by giving each received application 34 a color rating describing how close it is to the employer's application. If the job seeker application is green, then the application is considered close, if the job seeker application is yellow, then the application is considered not so close, and if the job seeker application is red, then the application is considered far from close. It is to be understood that other criteria can be utilized in the course matching operation 600. For this example, identity between these five parameters will be used for illustration purposes only.

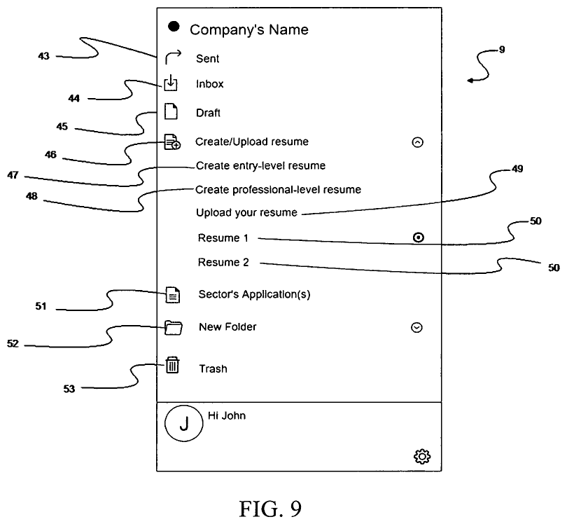

FIG. 9 is an exemplary side menu bar 9 presented to any user, either a job seeker or an employer/recruiter, with the necessary changes regarding both queries as stated in the earlier text above when clicking the menu icon 27. The job seeker side menu bar consists of a “sent” 43, an “inbox” 44, a “draft” 45, a “create/upload resume” 46, a “create entry-level resume” 47, a “create professional-level resume” 48, an “upload your resume” 49, existing resumes 50, a “sector's applications” 51, a “new folder” 52, and a “trash” 53 icon. The employer/recruiter menu is the exact same except for it doesn't have a resume section, nor have multiple sectors under its “sector's application.” The employer has one sector in its sector application which is the sector his company signed up under. Note: This is where the employer fills out the ideal application.

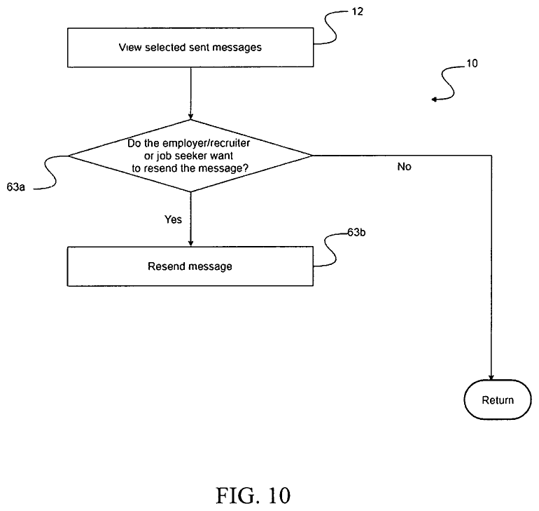

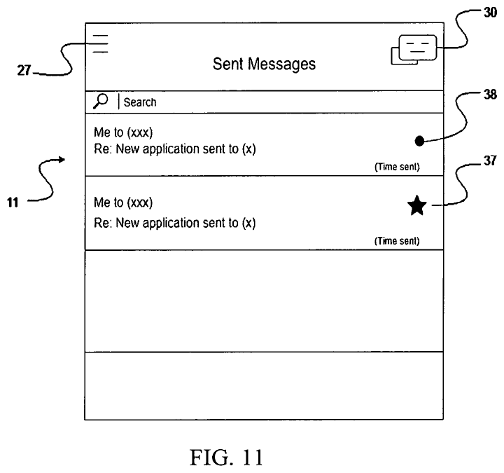

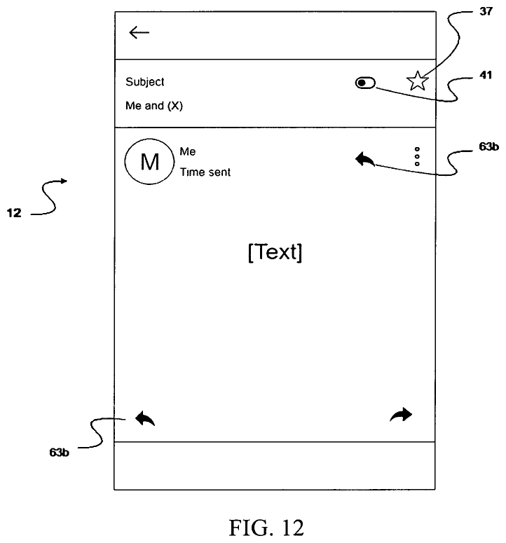

FIG. 10 shows a sequence of operation 10 when an employer/recruiter or job seeker views a “sent” message 12 on FIG. 12 that he has sent out earlier. If the employer/recruiter or job seeker decides to resend the message 63a then he must click the resend button 63b. If not, then he returns to the web page screen 11 on FIG. 11. Note: the orange star must be present within the job seeker's query to resend the message.

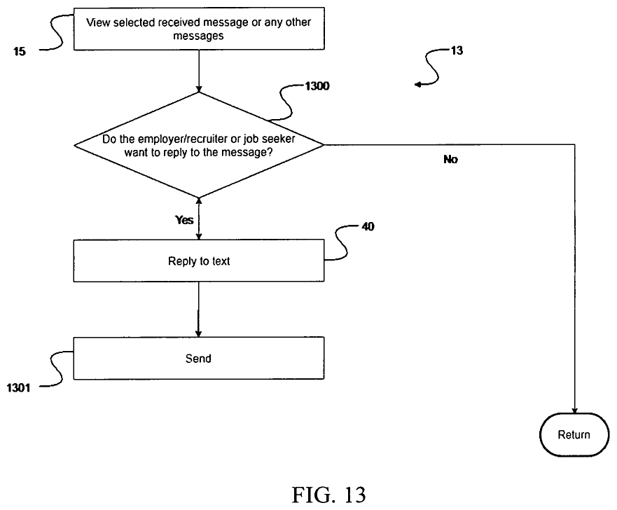

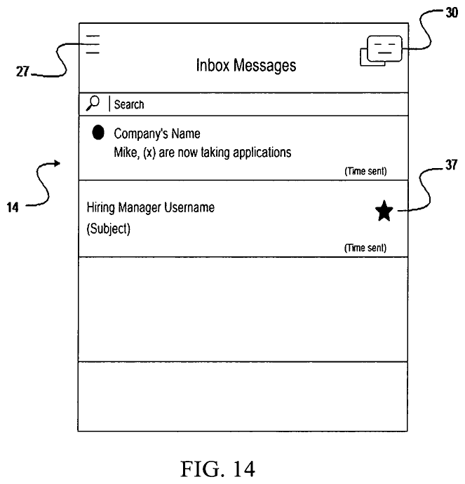

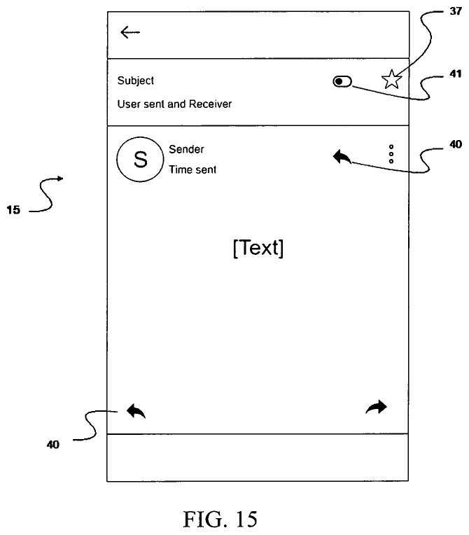

FIG. 13 shows a sequence of operation 13 when an employer/recruiter or job seeker views an “inbox” message 15 on FIG. 15 that he has received. If the employer/recruiter or job seeker decides to reply to the message 1300 then he must click the reply button 40 and send the message 1301. If not, then he returns to the web page screen 14 on FIG. 14. Note: The employer will have the option to either keep the conversation open or close 41 between him and the job seeker, and the job seeker must have an orange star 37 beside his inbox message to reply.

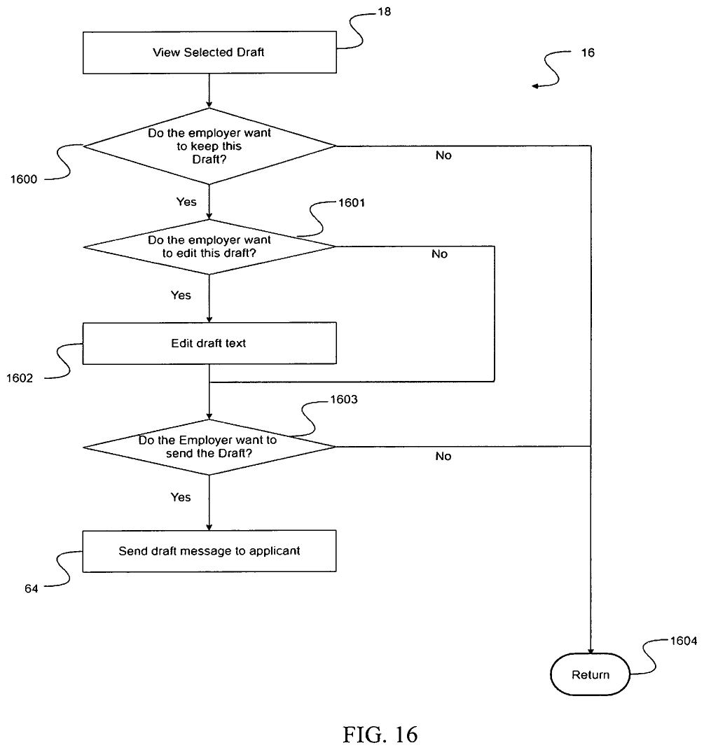

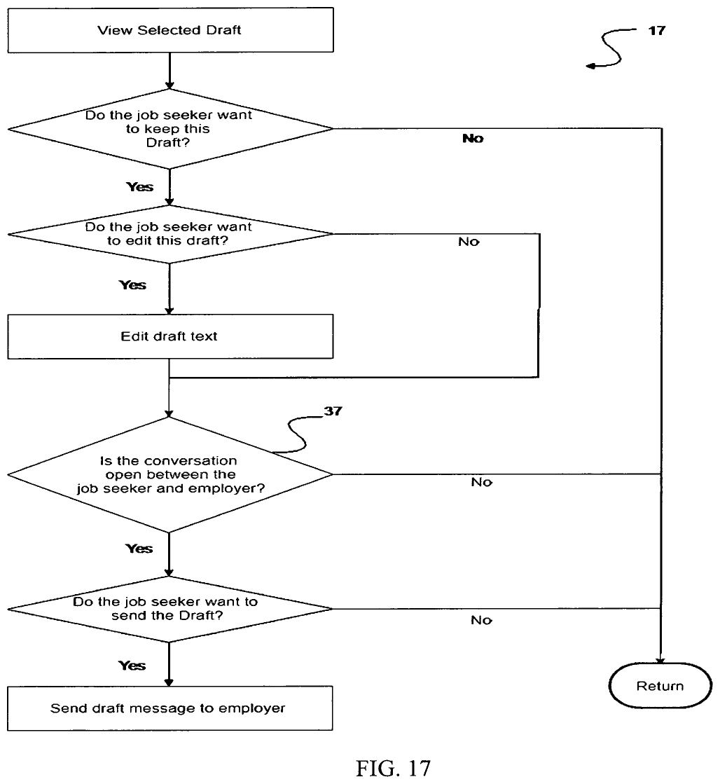

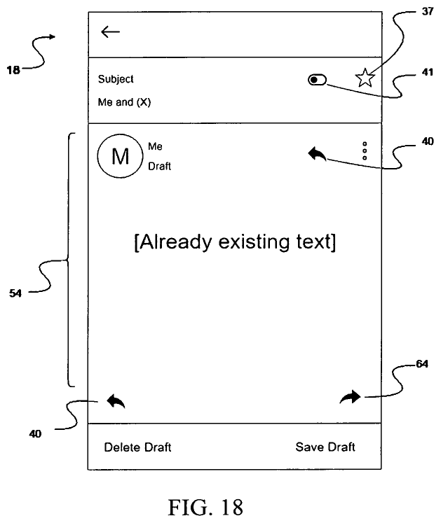

FIG. 16 shows a sequence of operation 16 when an employer/recruiter views a “draft” message 18 on FIG. 18 that he has not finished. If the employer decides to keep this draft 1600 then he will have the option to edit the draft 1602 if needed 1601. If the employer decides that the draft 54 doesn't need any editing 1601, then he will have the option 1603 to either send the draft 64 or save and return 1604 to the side menu 9. The job seeker's draft flow diagram 17 on FIG. 17 is the same as the employer's 16 with an addition of him knowing that the conversation is either open or close between him and the employer 37. Note: the draft message 18 on FIG. 18 is the same for the job seeker as it is for the employer/recruiter minus the “open and close conversation” button 41.

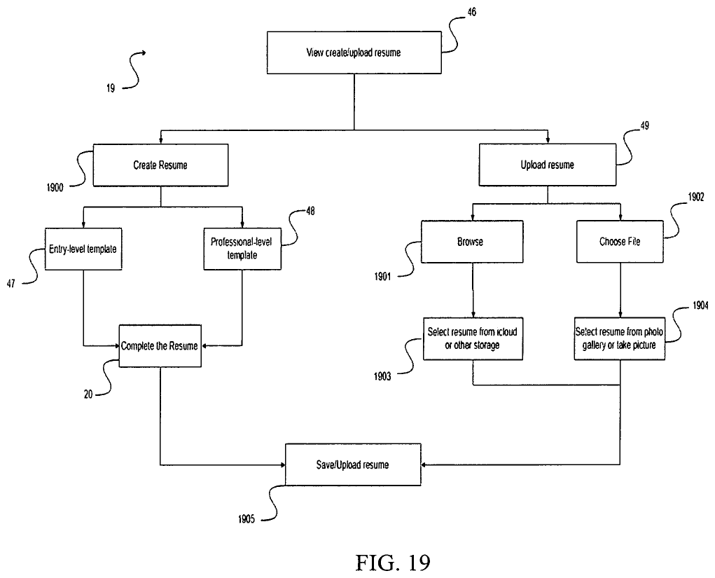

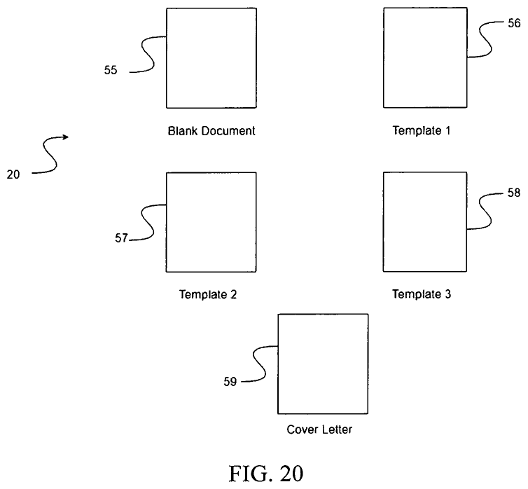

FIG. 19 shows a sequence of operation 19 when a job seeker views the “create or upload resume” 46 on FIG. 9. The job seeker then decides if he wants to create a new resume 1900 or upload his own resume 49. If the job seeker decides to create a new resume 1900 then he will have a choice of either creating an entry-level resume 47 or a professional-level resume 48. When either resume types are clicked, a web page screen 20 of FIG. 20 appears up suiting the selected resume of choice. This web page 20 will have 4 different resume templates 55, 56, 57,58, and a cover letter template 59. On the other hand, if the job seeker decides to upload his own resume, he will then have the choice to either browse 1901 it or choose one from his file 1902. If he chooses to browse 1901 then the application will take him to his iCloud or any other form of storage where his resume can be found 1903. If the job seeker decides to upload his resume from a file 1902, then he will be able to take a picture of his resume or select it from his photo gallery 1904. After the resume is created or uploaded 1905, it becomes an existing resume 50 on FIG. 9.

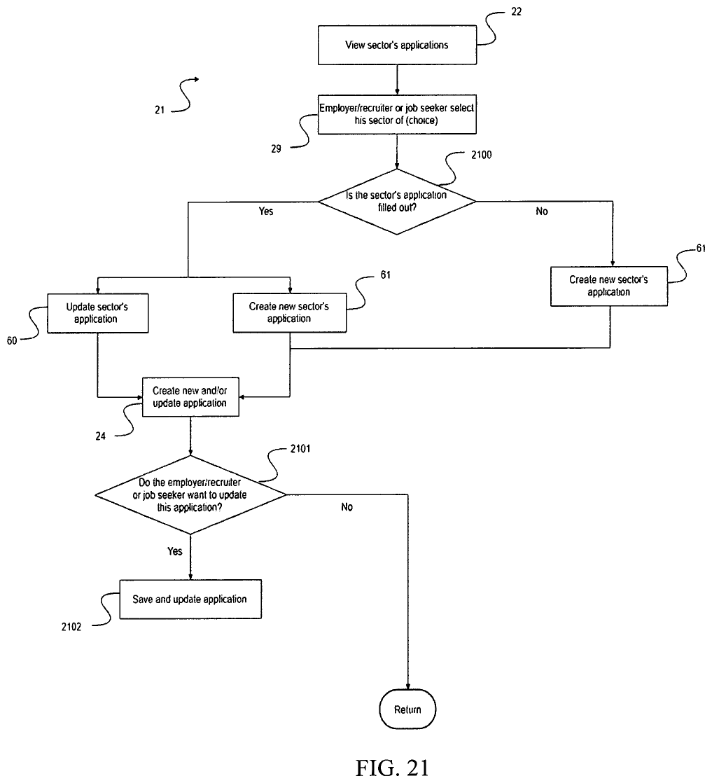

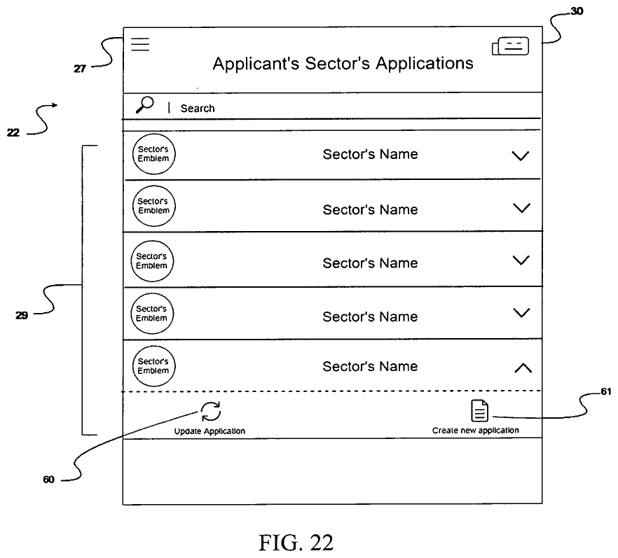

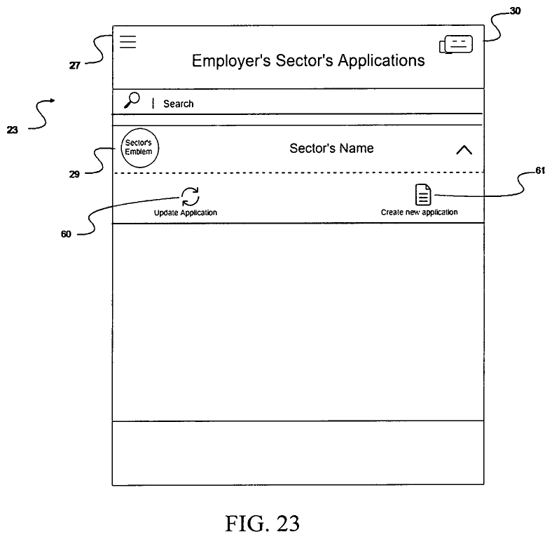

FIG. 21 shows a sequence of operation 21 when an employer/recruiter or job seeker views the “sector's application(s).” Regarding to the job seeker's query, web page screen 22 on FIG. 22 is presented to him consisting of all the job sectors 29 and their applications. If the job seeker has already filled out 2100 or started on an application 24 with a job sector, then he will have the option to either update the application 60 or create a new application 61. If he hasn't started on an application, then the update icon 60 is not available. Regarding to the employer/recruiter's query, web page screen 23 on FIG. 23 is presented to him consisting the job sector that his company has signed up under and its application. This is where the employer can fill out his ideal application 24. After the employer/recruiter or job seeker completes his application, he may then update it 2101 and save it to the system 2102. Note: the job seeker will have an upload resume icon 62 at the bottom of each sector's application 24 where he can upload his resume.

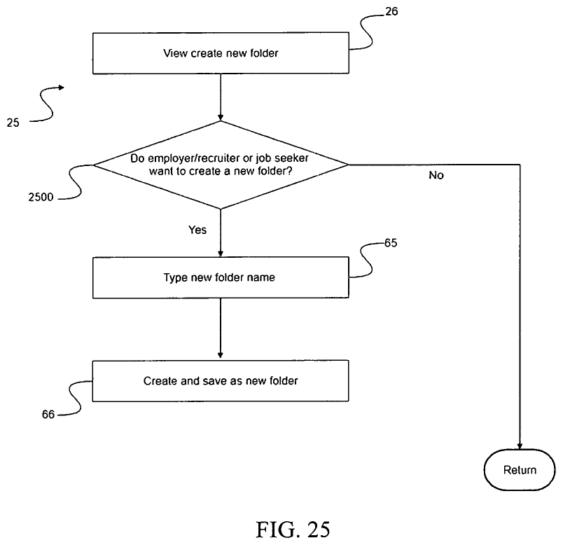

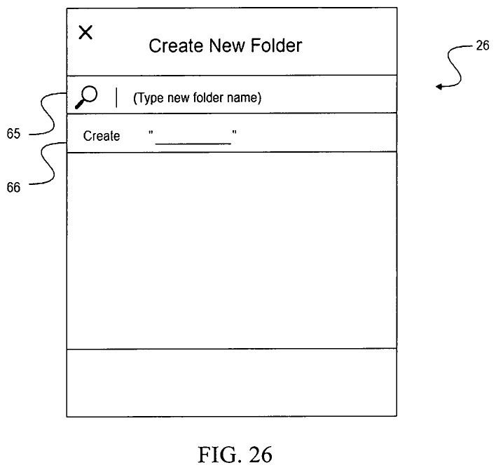

FIG. 25 shows a sequence of operation 25 when an employer/recruiter or job seeker views “create new folder” 26 on FIG. 26. If the employer/recruiter or job seeker wants to create a new folder 2500, then they must type in a new folder name 65 and press the “create” button 66 to save it. If not, then the employer/recruiter or job seeker returns to the menu.

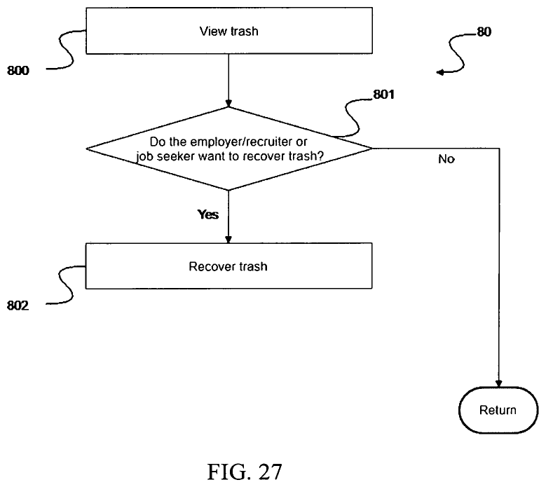

FIG. 27 shows a sequence of operation 80 when an employer/recruiter or job seeker views “trash” messages 800 on FIG. 27. Within this icon contains all the messages that are considered trash to the employer/recruiter or job seeker. If the employer/recruiter or job seeker wants to recover the trash 801, then he must press the “recover trash” button 802 to do so. If not, then employer/recruiter or job seeker returns to the menu.

1. A system for job searching, comprising: a computing device providing (1) a job seeker one job application per job sector for all the jobs under that sector that allows the applicant to bypass filling out each employer's job application individually which will be accepted by multiple employers under that sector and (2) an employer/recruiter one “ideal” job application for his job sector that will be used as a comparison tool to compare with the received applications that allows the employer to bypass filing out each applicant's job application which will be electronically sorted by the employer's liking; and a turn on and off button which allows the employer to choose when he is accepting application and when he is not accepting applications; wherein said comparison-operation-subjected set will include the employer's application which includes the employer's-indicated location, employer's-indicated scenario answers, employer's-indicated skills, employer's-indicated qualifications, and employer's indicated availability and the job seeker's application which includes the job seeker's-indicated location, job seeker's-indicated scenario answers, job seeker's-indicated skills, job seeker's-indicated qualifications, and job seeker's-indicated availability; and providing, via the computing device, an accurate comparison score and sorting method for the employer and an application color rating score for the job seeker after he applies for the job; arising from the said processor-executed comparing operation.

2. The method of claim 1, wherein the computing device provides one job application for each job sector under a job seeker's and employer/recruiter's query.

3. The method of claim 1, wherein the user of the job application is one of a job seeker.

4. The method of claim 1, wherein the user of the ideal job application is one of an employer or recruiter

5. The method of claim 1, wherein said comparing-operation-subjected of applications includes a job seeker's application and an employer's application.

6. The method of claim 5, wherein the employer/recruiter application includes one or more employer's-indicated location, employer's-indicated scenario answers, employer's-indicated skills, employer's-indicated qualifications, and employer's-indicated availability, and the job seeker's application includes one or more job seeker's-indicated location, job seeker's-indicated scenario answers, job seeker's-indicated skills, job seeker's-indicated qualifications, and job seeker's-indicated availability.

7. The method of claim 5, further comprising providing to the job seeker, by the computing device, a location score, a scenario answer score, a skill score, a qualification score, and an availability score for an overall color rating score of his application compared to an employer's application.

8. The method of claim 5, further comprising providing to the employer/recruiter, by the computing device, a location score, a scenario answer score, a skill score, a qualification score, and an availability score for an overall color rating score of a job seeker's application compared to his application with a sorting method after the job seeker has applied to his job.

9. The method of claim 1, further providing, by the computing device, a turn on and off button that allows the employer to choose when he is accepting applications and when he is not accepting applications.

10. A processor-executed apparatus, comprising: a server storing and configured to execute instructions to: provide (1) a job seeker one job application per job sector for all the jobs under that sector that allows the applicant to bypass filling out each employer's job application individually which will be accepted by multiple employers under that sector and (2) an employer/recruiter an ideal job application for his job sector that will be used as a comparison tool to compare with the received applications that allows the employer to bypass filing out each applicant's job application which will be electronically sorted by the employer likings; and a turn on and off button which allows the employer to choose when he is accepting application and when he is not accepting applications; wherein said comparing operation-subjected set will include the employer's application which includes the employer's indicated location, employer's-indicated scenario answers, employer's-indicated skills, employer's indicated qualifications, and employer's-indicated availability and the job seeker's application which includes the job seeker's-indicated location, job seeker's-indicated scenario answers, job seeker's indicated skills, job seeker's-indicated qualifications, and job seeker's-indicated availability; and providing, via the computing device, an accurate comparison score and a sorting method for the employer and an application color rating score for the job seeker after he applies for the job; arising from the said processor-executed comparing operation.

11. The apparatus of claim 10, wherein the instructions provide one job application for each job sector under the job seeker's and employer/recruiter's query.

12. The apparatus of claim 10, wherein the user of the job application is one of a job seeker.

13. The apparatus of claim 10, wherein the user of the “ideal” job application is one of an employer or recruiter

14. The apparatus of claim 10, wherein said comparing-operation-subjected of applications includes a job seeker's application and an employer's application.

15. The apparatus of claim 14, wherein the employer/recruiter's application includes one or more employer's-indicated location, employer's-indicated scenario answers, employer's-indicated skills, employer's-indicated qualifications, and employer's-indicated availability, and the job seeker's application includes one or more job seeker's-indicated location, job seeker's-indicated scenario answers, job seeker's-indicated skills, job seeker's-indicated qualifications, and job seeker's-indicated availability.

16. The apparatus of claim 14, regarding the job seeker, further comprising instructions for a location score, a scenario answer score, a skill score, a qualification score, and an availability score for an overall color rating score of his application compared to an employer's application.

17. The apparatus of claim 14, regarding the employer/recruiter, further comprising instructions for a location score, a scenario answer score, a skill score, a qualification score, and an availability score for an overall color rating score of a job seeker's application compared to his application with a sorting method after the job seeker has applied to the job.

18. The apparatus of claim 10, further comprising instructions for a turn on and off button that allows the employer to choose when he is accepting applications and when he is not accepting applications.
